(19) United States
(12) Patent Application Publication
(10) Pub. No.: US 2004/0230463 A1
(43) Pub. Date: Nov. 18, 2004

(54) Performance management by results-based scorecarding

(75) Inventor: Pierre Y. Boivin, Ottawa (CA)

Correspondence Address: VOLPE AND KOENIG, P.C., UNITED PLAZA, SUITE 1600, 30 SOUTH 17TH STREET, PHILADELPHIA, PA, 19103, US

(73) Assignee: Results Based Scorecards Inc., Ottawa (CA)

(21) Appl. No.: 10/439,145

(22) Filed: May 15, 2003

(51) Int. Cl. G06F 17/60

(52) U.S. Cl. 705/7

(57) ABSTRACT

Disclosed is a system and method of performance management utilizing results-based scorecarding. The method associates plan elements, performance indicators, and targets during status publication time points. The performance indicators are indicative of physical activity or objects n a focus on results. The method provides a technique for private and public sector organizations and their managers to meet on-going responsibilities in a timely and efficient manner while providing for greater on-going overall organizational and management transparency and accountability.

### FIELD OF THE INVENTION

The present invention relates to performance management by results-based scorecarding and is particularly concerned with ongoing cyclical program management.

### BACKGROUND OF THE INVENTION

There is growing demand by the general public for greater on-going overall organizational and management transparency and accountability from both the private and public sectors.

Private and Public Sector organizations and managers are simultaneously being asked to accomplish more and more with fewer and fewer resources. There is a need for management systems that can help them to keep track of their overall aims and desired results in an easy and efficient manner without adding to their already significant workload.

Most available management systems help manage projects or supply chains or are event-lagging performance measurement systems. Examples of existing management systems include Management by Objectives, Baldrige Quality Management, the Balanced Scorecard Collaborative system, and Six-Sigma style systems.

The Management by Objectives (MBO) methodology is a performance appraisal methodology which focuses on integrating individual and organizational objectives into management. The principle behind MBO is to make sure that everybody within the organization has a clear understanding of the aims, or objectives, of that organization, as well as awareness of their own roles and responsibilities in achieving those aims. Tasks are delegated by “negotiating a contract of goals” with subordinates without dictating a detailed roadmap for implementation.

The Baldrige Quality Management system is a rigorously designed and meticulously applied methodology using seven specific categories of criteria, eleven specific core values and five key characteristics which are related by a composite of indicators, balanced strategies, results, assessments and a scoring system. The net aim is to produce a particular grade of performance quality in an organization.

The Balanced Scorecard Collaborative system uses a system of strategies, perspectives, measures, assessments and scorecards with a focus on maintaining a balance of priorities among the specified perspectives. Perspectives are normally representative of business aspects and stakeholders. A public sector example might name the perspectives of Citizens, Budget, Internal Business Processes and Organization Capacity. In such an example a set of scorecards is published at points during the year, each scorecard having the required data entered for each of the perspectives including their respective objectives, measures and performances. The resulting scorecard is used to assess the degree of balance of the status among all the perspectives, with intent to direct management attention and effort to out-of-balance perspectives.

The Six Sigma style systems historically derived from shop floor production performance management, with intent to maintain specific production processes within a controlled range and with a controlled degree of variance. The net result was an extreme degree of quality control effectiveness for a particular production process.

In view of the foregoing, it would be desirable to provide a technique for helping private and public sector organizations and their managers to meet on-going responsibilities in a timely and efficient manner that overcomes the above-described inadequacies and shortcomings.

### SUMMARY OF THE INVENTION

An object of the present invention is to provide an improved performance management system predicated upon results-based scorecarding.

According to a first aspect of the invention there is provided a method for controlling a set of elements defined in a plan, the method having the following steps. First, defining a set of performance indicators corresponding to said elements, said performance indicators indicative of objects or physical activity. Next, establishing a plurality of phases, each of said phases corresponding to a subset of the elements of said set of elements and at least one of said phases being an evaluation phase. Next, publishing a record at intervals of time, at least one interval coinciding with an annual management cycle, said record comprising a quantification of said performance indicators at the time of publishing.

Conveniently, there may also be a step of defining a set of data sources associated with the elements, and the published record may be in the form of a table.

According to another aspect of the invention, there are additional steps of defining a formulaic expression for calculating a quantity associated with a respective performance indicator. As well, a desired target quantity may be associated with a particular performance indicator, and a date associated with the target quantity.

According to another aspect of the invention there is a method where the number of the plurality phases is established at six. First, establishing an inputs phase wherein approvals are obtained for the plan. Next, establishing an activities phase wherein structures for executing the elements are defined. Next, establishing an outputs phase wherein the structures are implemented. Next, establishing an immediate outcomes phase wherein a set of products of the structures are quantified. Next, establishing an intermediate outcomes phase wherein a set of quality assessments of said set of products are quantified. Next, establishing a strategic outcomes phase wherein an assessment of an overall performance against said plan is quantified. Finally, publishing at intervals of time a record of such quantifications as have been achieved at that point in time.

According to a further aspect of the invention there is disclosed a reference indicator associated with each performance indicator and conveying information about syntax and phase relationship among plan elements. The reference indicator may be a combination of alphabetic and numeric characters conveying information about which element and phase a respective performance indicator relates to as well as enumerating the performance indicators related to a given element.

Conveniently, the published form of the records may be in tabular format for ready association of plan elements, performance indicators, results, and other recorded values.

The present invention will now be described in more detail with reference to exemplary embodiments thereof as shown in the appended drawings. While the present invention is described below with reference to the preferred embodiments, it should be understood that the present invention is not limited thereto. Those of ordinary skill in the art having access to the teachings herein will recognize additional implementations, modifications, and embodiments, which are within the scope of the present invention as disclosed and claimed herein.

### BRIEF DESCRIPTION OF THE DRAWINGS

The invention will be further understood from the following detailed description of embodiments of the invention and accompanying drawings, in which:

FIG. 1 is a diagram of an example empty record relating elements, performance indicators, data sources and phases according to an embodiment of the invention.

FIG. 2 is a diagram of an example empty record relating reference indicators, performance indicators, formulaic expressions, and target quantities according to an embodiment of the invention.

FIG. 3 is a plot of an example empty record relating reference indicators, performance indicator values, status, targets, and performance indication according to an embodiment of the invention.

FIG. 4 is a diagram of an example record with entries relating elements, performance indicators, data sources and phases according to an embodiment of the invention.

FIG. 5 is a diagram of an example record with entries relating reference indicators, performance indicators, formulaic expressions, data sources, and target quantities according to an embodiment of the invention.

FIG. 6 is a plot of an example record with entries relating reference indicators, performance indicator values, status, targets, and performance indication according to an embodiment of the invention.

Note that like reference numbers indicate similar features across the different Figures.

### DETAILED DESCRIPTION

As with most systems of explicit organizational control, this method will use as an input a plan, typically defined by management, having elements which describe desired results of the plan. The plan could be for a program or business line or organizational unit.

In order to effectively accomplish the elements of the plan a system of records relating the elements to performance indicators is used. The performance indicators are subject matter representative of or constituting physical activities or objects. Preferably the records are tabular in form. Certain of such records could conveniently be referred to as scorecards in terms of their use in tracking the performance indicators related to the plan elements.

Typically, to assist in establishing accountability, owners would be identified for the scorecards. The owners might be the managers responsible for the program or business line or organizational unit in question. All the information included in the tables would be approved by the appropriate management level prior to the beginning of the annual funding or business cycle.

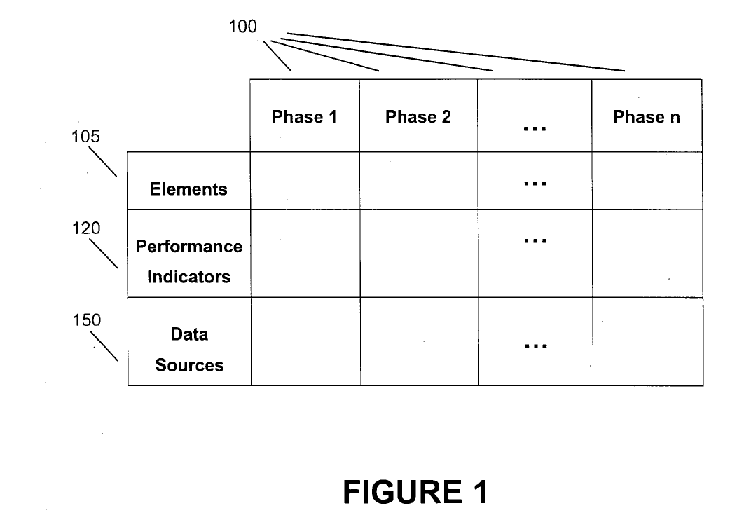

FIG. 1 provides an example of an initial record form that an owner would fill to provide some of the basic information needed to build a scorecard.

In FIG. 1 may be seen a series of column headings that represent phases 100 of the plan. A typical plan has a plurality of phases as indicated. Also in FIG. 1 may be seen rows demarking the elements 105, performance indicators 120, and data sources 150 associated with the plan. The tabular format conveniently relates the elements to the other aspects of the plan.

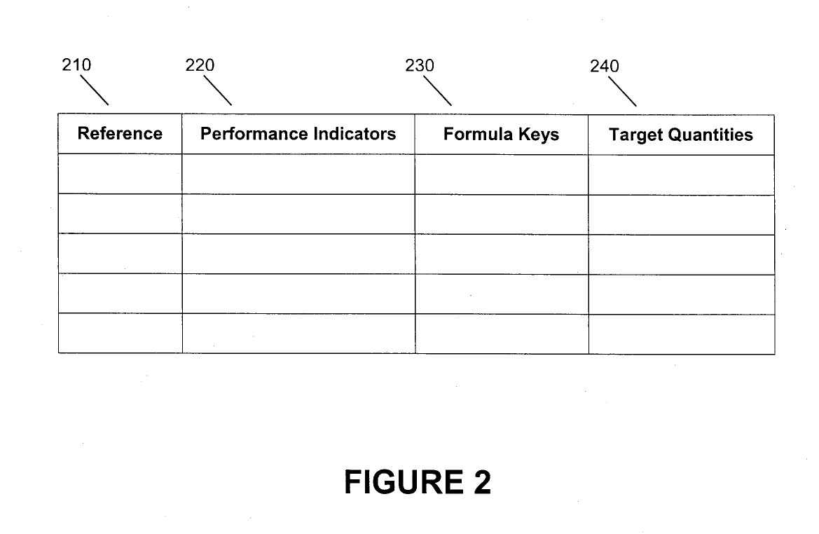

In FIG. 2 may be seen an example of another record form that an owner would fill in to provide further information necessary to build a scorecard.

In FIG. 2 may be seen a series of columns denoting reference indicators 210, performance indicators 220, formula keys 230 and target quantities 240. A specific reference indicator is a means of identifying a respective performance indicator. Although multiple types of reference indicators are possible, a preferred version constitutes a hash of a numeric portion representing a phase and an alphabetic portion representing an element as well as a further numeric portion further specify which of a potential plurality of performance indicators. Such a combination provides syntax information as to order of performance indicators. As such a given performance indicator may be readily correlated to a phase and element of the plan. The formula keys associated with each performance indicator comprise formulaic expressions which yield a quantitative value. The formulaic expression will typically draw upon data from the data sources specified in the previously discussed record. The formulaic expressions will be quantitative indications representative of objects or physical activities. The target quantity represents a desired achievement expressed in the same units as the formulaic expressions. There may be a date (not shown in the present example) associated with the respective target quantity.

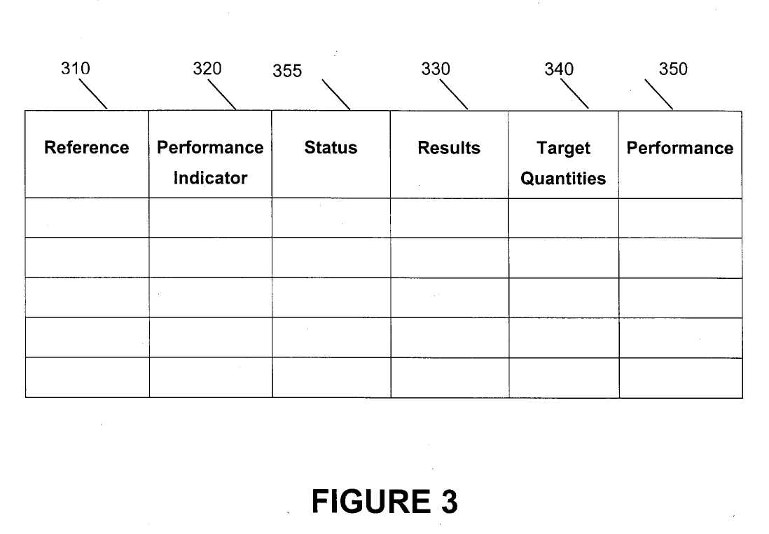

In FIG. 3 may be seen an example of another record form that an owner would fill in to represent the results at a particular publication time.

In FIG. 3 may be seen a series of columns denoting reference indicators 310, performance indicators 320, status 355, results 330, target quantities 340 and performance ranking 350. A specific reference indicator is a means of identifying a respective performance indicator as per the previously described record. The results 330 provide a point for the quantitative value of the performance indicator as calculated by its respective formulaic expression to be recorded. The quantitative value is calculated pertinent to the publication point in time and thus represents a report on the state of results at that particular point in time for that particular element. The respective target quantities are those described previously. The performance ranking 350 provides a point for an entry representing a comparison of the actuals of a particular performance indicator versus its respective target quantity. An example performance ranking might be a percent calculation showing what percent of the target results the actuals has attained at the publication point. The status 355 provides the point for an entry relating the performance to a threshold or a set of thresholds. An example status might be an iconic indicator with a particular color for an actual more than 80% complete, and a different color for performance indicator with an actual which has a current result of less than 10% of its respective target. The thresholds and performance indicators could be recorded as supplemental entries to the record described in FIG. 2.

Having provided an overview, following is a more detailed example of a possible implementation of the method. In the following example a set of six phases is utilized. A particular reference indicator scheme is illustrated and example names are provided for plan elements, performance indicators, data sources and the like. In the following example, elements of the plan may be described as Results as appropriate in context, but are not to be confused with the quantitative indications of objects or physical activities that are reported for the performance indicators at time of publication.

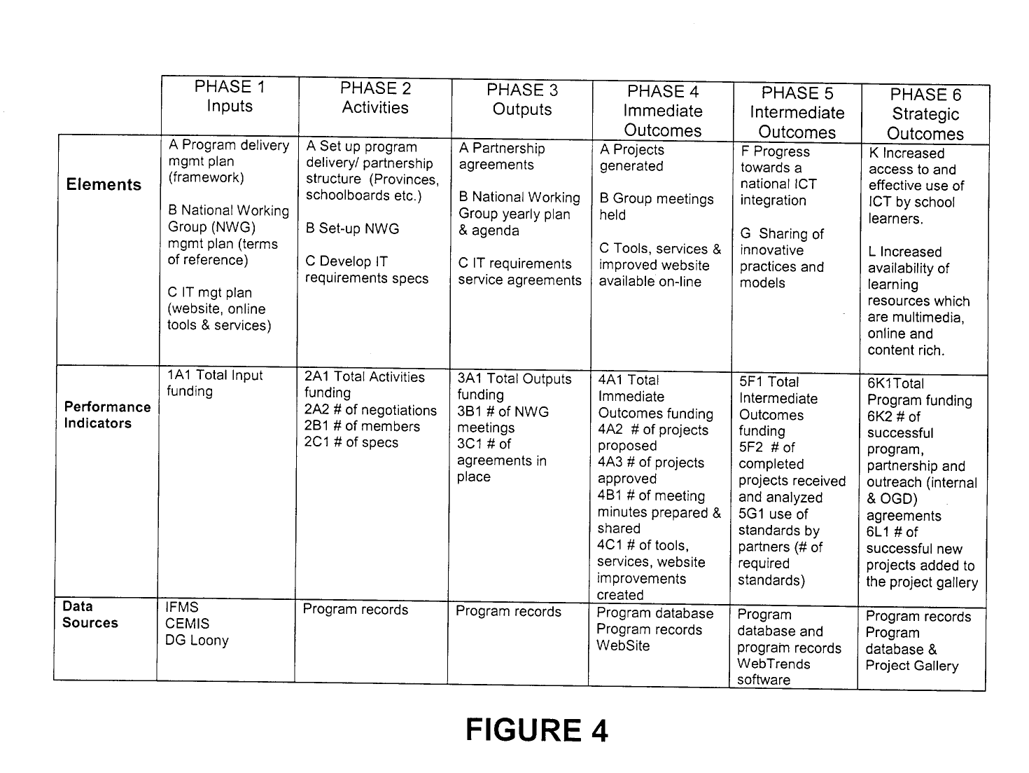

In FIG. 4 may be seen a partially filled-in example of the record described previously with reference to FIG. 1. The first row describes six phases that comprise an annual results-based management cycle. Although there may be as many phases as the owner desires, an average of six would be sufficient to meet the particular results-based scorecards system requirements for this example.

Note that in the reference indicator used, phases are numbered, elements have capital letters and performance indicators have numbers corresponding to the phases, capital letters corresponding to the elements, and further numbers accounting for the case of a plurality of performance indicators directed to the same element within a phase. This greatly facilitates the tracking of these various items and indicates the linkages between them. For example, when listing the various performance indicators in records corresponding to FIGS. 2 and 3, the reference indicator schema used allows one to quickly ascertain the actuals and phases related to any performance indicator and to quickly track and identify linked items in the system.

Input Phase 1 is the initial Phase at the start of the fiscal year. It represents the initially approved yearly management plans and funding or budget for the program or business line or organizational unit.

The Results of the Input Phase are the critical elements required for the management of the program or business line or organizational unit during the annual business cycle.

Each element is then tracked during the subsequent phases of the publication cycle through corresponding results in the subsequent phases. Thus element 1A in Phase 1 is directly related to element 2A in Phase 2, 3A in Phase 3 etc. Each related element in the subsequent phases generally represents a managerial milestone for the essential category element 1A. The milestones are explained for each subsequent phase below.

Note that the later Phases 5 and 6 usually have fewer elements than the preceding phases. That is because these phases describe higher-level organizational elements and that the earlier lower-level elements tend to be grouped into the fewer higher-level elements. Also, there can be in any phase, particularly the later ones, stand-alone elements that appear and have their own stand-alone performance indicators.

There is only a single performance Indicator in the Input Phase of this example because, although there are 5 elements, there is only one performance indicator: the total funding or budget for the Input Phase. This is because, typically, all that an organization has at the start of the fiscal year are approved management plans and an approved funding level or budget. No action has been taken yet. Subsequent phases have at least one performance indicator for each element.

Whereas there tend to be fewer elements in the later Phases 5 and 6, the number of performance indicators tends to remain constant because of the need to evaluate and declare successes for all the preceding performance indicators which reflect the main management categories of the program, business line or organizational unit.

A preferred approach illustrated in this example is that only the total funding is given for each Phase, i.e. there is no breakdown by element. This assists in discouraging micro-management by more senior managers which should only be concerned with macro-management and exception reporting. The Total funding performance indicator is usually associated with the most important of the elements.

Exception reporting would generally occur when a performance indicator's result is less than 90% of its target quantity at the target date for that performance indicator. Then the published record or scorecard (e.g. a record as in FIG. 3 with appropriate entries) will signal the need for an exception report for that performance indicator. At this point the performance indicator becomes a risk indicator. The owner of that Scorecard/Phase/Result/lndicator will typically have to supply a comment for that performance indicator. For that purpose, it is likely that the owners of scorecards would get to see the scorecards first so that they could provide explanatory comments before more senior management sees the scorecards. The comment might advise as to what risk management plan covers this eventuality and what identified risk contingencies have been put into place. Alternatively, if the risk management plan did not cover the cause of the exception then the comment might state this fact and that the exception will be incorporated into future risk management plans, as well as what temporary contingencies have been put in place.

Activities Phase 2 follows Input Phase 1 and this phase's essential Results identify the main activities required to set up the structures required for the corresponding Phase 1 Results' management plans. There is usually at least one Activities Result corresponding to each preceding Input Phase Result. Examples could be setting up IT requirements specifications or partnership structures

In addition to the Total Activities funding or budget Performance Indicator, there is usually at least one Activities Performance Indicator for each Activities Result. These indicators would typically represent a most important quantifiable structural characteristic of each Activities Result. Examples could be the number of IT specifications required or the number of negotiations required to set-up a business line or an oversight committee.

Phase 3 in FIG. 4 is the Outputs Phase and this phase's Results identify the main result of the Activities Phase Results. There is usually at least one Outputs Result corresponding to each preceding Activities Phase Result. Examples might be IT requirements service agreements or the number of business line final agreements.

In addition to the Total Outputs funding or budget Performance Indicator, there is usually at least one Outputs performance indicator for each Outputs Result. These Indicators represent the most important quantifiable output characteristic of each Outputs Result. Examples could be the number of signed agreements or the number of internal critical actions required to manage an organizational unit. Note that these Indicators would also relate to the preceding Activities Phase's corresponding Indicators.

Phase 4 in FIG. 4 is the Immediate Outcomes Phase and this Phase's Results identify the main result of the Outputs Phase Results. This Phases Results represent the main items produced by the program or business line or organizational unit during the business cycle. There is usually at least one Immediate Outcomes Result corresponding to each preceding Outputs Phase Result. Examples would be IT Tools and services produced/provided or the number of business line products sold.

In addition to the Total Immediate Outcomes funding or budget performance indicator, there is usually at least one Immediate Outcomes performance indicator for each Immediate Outcomes Result. These performance indicators might represent the most important quantifiable product characteristic of each Immediate Outcomes Result. Examples could be the number of products sold or deliverables received or goals achieved. Note that these Indicators could also relate to the preceding Inputs Phase's corresponding Indicators.

Phase 5 in FIG. 4 is the Intermediate Outcomes Phase and this phase's Results evaluate the main results of the Outputs Phase Results or the implementation of the overall management plan Results of the Input Phase. There could usually be at least one Intermediate Outcomes Result corresponding to each preceding Immediate Outcomes Phase Result. However, this Phase's Results start to represent higher-level organizational Results. As such there may be fewer Results into which the more numerous previous Phases' Results blend. Examples would be progress made toward achieving homogeneous organizational goals or the identification and sharing of best practices.

In addition to the Total Intermediate Outcomes funding or budget performance indicator, there is usually at least one Intermediate Outcomes performance indicator for each Immediate Outcomes Result. These Indicators might represent the most important characteristic that should be evaluated for each Intermediate Outcomes Result. Examples could be the number of products sold evaluated or the number of deliverables and/or goals analyzed. Note that these Indicators might also relate to the preceding Immediate Outcomes Phase's corresponding performance indicators.

Phase 6 in FIG. 4 is the Strategic Outcomes Phase and this phase's Results represent the highest level organizational strategic Results. As such there are usually fewer Results than in previous Phases. Nonetheless the preceding Intermediate Phase Results should easily correspond and blend into the fewer Strategic Results. Examples might be national and international Results.

The first performance indicator is the Total Program funding or Total Budget for the program or business line or organizational unit. The target quantity for this indicator should be the same value as for the Phase 1 Total Inputs funding or Total Budget performance Indicator.

In addition to the Total Program funding or budget performance indicator, there is usually at least one Strategic Outcomes performance indicator for each Strategic Outcomes Result. These performance indicators represent the number of successes resulting from the preceding Phase 5 evaluation of the corresponding performance indicators. Contrary to the fewer number of Results in this Phase, there are usually therefore at least as many performance indicators in this Strategic Phase as in the preceding Intermediate Phase. Examples might be the number of successful products sold or the number of successful deliverables and/or goals.

FIG. 4 provides a filled-in example containing the basic information that is required to build the basic scorecard. Typically a computer system using performance management software is utilized for data capture and record publication.

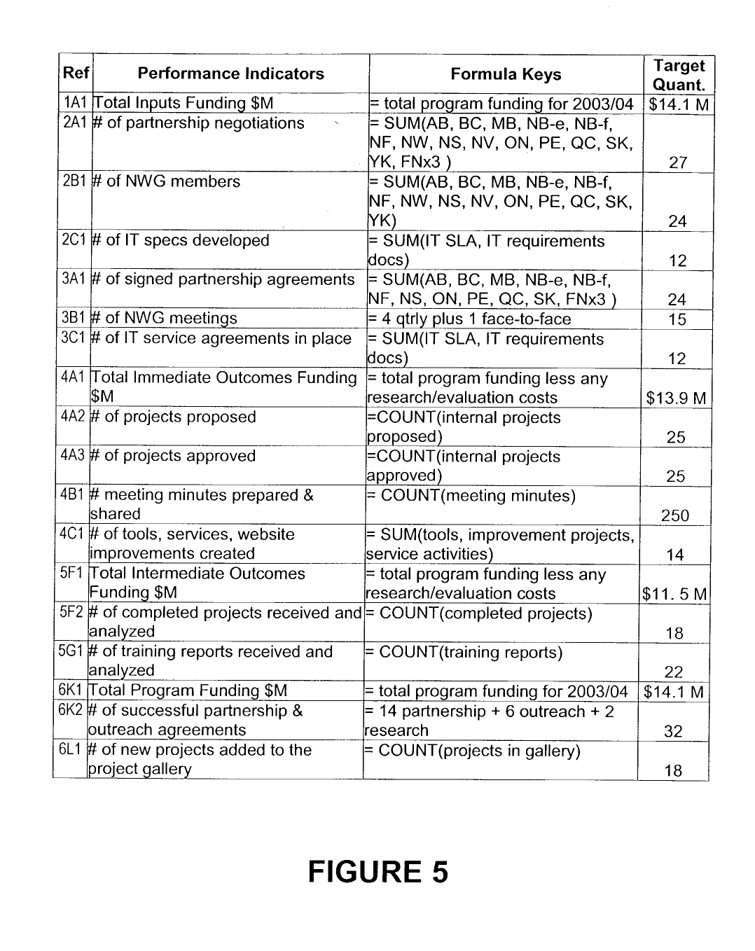

FIG. 5 provides a filled-in example table that each scorecard owner/manager would fill to provide the formulaic key and target quantity for each performance indicator. Again, typically a computer system using performance management software is utilized for data capture and record publication.

The Ref and Performance Indicators columns list the reference indicator and performance indicators respectively that were developed and are listed in the Performance Indicators row of the table depicted in FIG. 4 described above.

The Keys column describes the quantitative formula used to arrive at the results value for each performance indicator. Data for the quantitative formula is located in the Data Sources row of the table depicted in FIG. 4 described above. The Target Quantities are able to be calculated according to the same quantitative formula. An optional record (not illustrated) denoting the respective rationale for each target quantity may be used. The Target Quantities are typically set and approved by the appropriate level of management prior to the annual funding or business cycle.

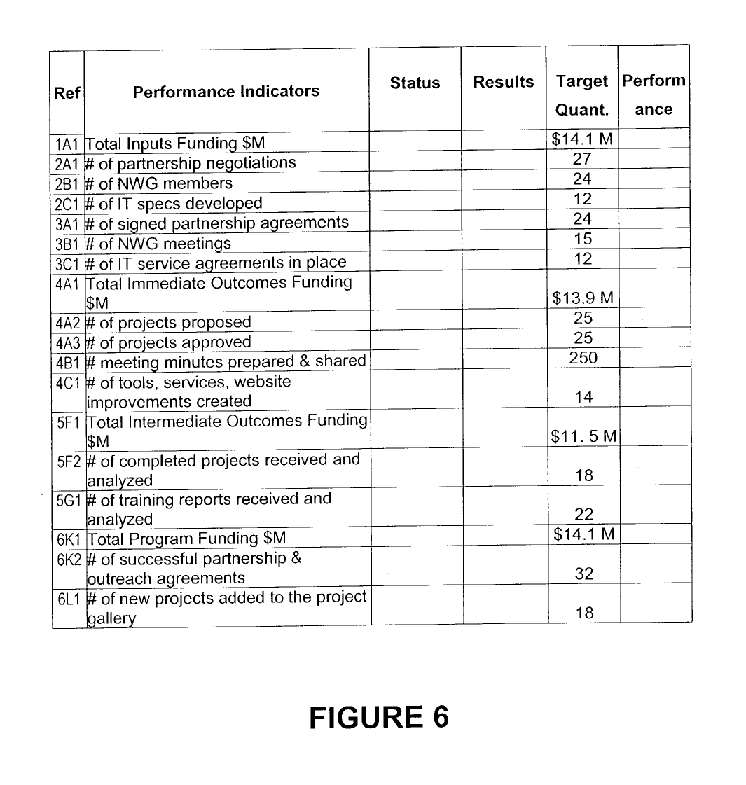

FIG. 6 provides a partially filled-in example containing the basic information that is required to build the basic scorecard. Typically a computer system using performance management software is utilized for data capture and record publication at the various publication points in time.

As in the example depicted FIG. 3 above, the Ref and Performance Indicators columns list the reference indicator and performance indicators respectively that were developed and are listed in the Performance Indicators row of the record described in the description of FIG. 5 described above.

The Results column contains the results values for the performance indicators that are to be published in the record at the time of publication. As mentioned in the description of FIG. 5, these values are computed using the quantitative formulaic expression provided.

The Target column contains the respective values that were recorded in the description of FIG. 5.

The Performance column contains a formula for each performance indicator which compares the Results value to the Target Quantity and arrives at a measure to compare to a previously determined of threshold value or values. Although any formula can be used, a preferred formula is to express the Results value as a percentage of the Target Quantity. For illustrative purposes, that is the formula that will be utilized here.

The Status column provides an entry for an iconic indicator which indicates if a performance indicator's Performance relative to the threshold value or values. Examples of contemplated iconic indicators are using visual symbols such as a green upwards pointing arrow for above threshold values, a yellow horizontal arrow for equal to threshold values and a downward pointing red arrow for below threshold values. The below threshold values would thus be flagged so that more senior management viewing the scorecard would be alerted that this Indicator/Result/Phase/Scorecard merited further investigation.

Calculation of the various formulae would usually be accomplished on performance management software. It is contemplated that use of such software would facilitate linking to additional information such as Vision and Mission statements. Further links to existing supporting documents for the various elements of the scorecards such as strategic policies, performance management frameworks etc., would be facilitated.

In terms of alternative embodiments contemplated it is also important to note that FIG. 1 described above may be considered the visual representation of the Logic Model resulting from the application of the method to a program or organization. This Logic Model can then be used to describe the essential “raison d'être” of the program or organization in question. FIG. 1 also represents a vertical or more hierarchic representation of a Logic Model suited to vertical programs or organizations. Application of the method to a horizontal organization or business line will result in a horizontal Logic Model which includes the same steps and possibilities as the vertical application described in this application. Similarly, if the emphasis desired is to show the application of the method to a lifecycle approach then the resulting Logic Model will be circular in nature with the last or Strategic Outcomes Phase connecting to the first Input Phase in a circle of phases emphasizing the lifecycle aspect.

As an adjunct to the method, it is clear to one skilled in the art that there is required a management approval system for the management plans including the approval of all the plan elements described above: including the scorecards, phases, results, performance/risk indicators, target quantity and their keys, threshold values, publishing dates, scorecard owners, risk management plans and proposed risk solutions when target thresholds are not met, etc. Once the system is in place, then all the elements are approved for the individual scorecards part of the management plan prior to their implementation in the scorecarding system itself and the scorecard records serve to keep the focus on results.

In addition to the above management scorecards, the method provides, as mentioned before, a lifecycle system. This means that although the system includes the multiple phases described above, it is not limited to the number described: there can be fewer or more numerous phases as long as the integrity of the lifecycle approach is maintained. This means that the cycle has to include the various results described for each phase but these results can be compressed into fewer and more general phases or expanded into more numerous and detailed phases. Also, the final phase can be expanded to include as a result, the management plans and requested funding/budgets for the next cycle.

In terms of yet further applications contemplated by the inventor, it is possible to extend the method external to an organization. Once the method has been applied to an organization it can then be expanded to include the organization's supply chain and customer chain. The suppliers and customers are then brought into the method by the application of the method to their interactions with the organization. An example would be the application of the method by a Foundation to its beneficiaries. The beneficiaries would be required to apply the method to their programs and organization and to report to the Foundation through the interaction of the two organizations' systems. Ideally such an interaction would be supported by networked computer systems.

A performance management system and business method that allows private or public sector managers to manage, on an on-going basis, their business lines or programs at any level in their organizations, i.e. from the top strategic level to the hands-on operational level has been disclosed.

Although this performance management system is a stand-alone system which can be utilized on manually-filled forms or with basic spreadsheet and graphic software packages, it is contemplated to be easily implemented with existing Performance Management Software Systems such as SAS Strategic Performance Management software or the SAP\R3 Strategic Enterprise Management (SEM) Module.

This performance management method can be utilized by a single organizational unit and is also scalable to any size organization. The method is flexible and can be adapted to meet the requirements of a wide type of organizational structures, e.g. hierarchical or horizontal or networking structures.

This performance management method is readily adapted to a lifecycle management approach, including an evaluation phase, based on an annual (calendar or financial) management cycle. It promotes the sharing and early warning of management problems and proposed solutions without encouraging micro-management. The overall system encourages an iterative, continuous learning approach to management while focusing on accountability, results and risk management.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A method for controlling a set of elements defined in a plan, the method comprising the steps of:
defining a set of performance indicators corresponding to said elements, said performance indicators indicative of objects or physical activity;
establishing a plurality of phases, each of said phases corresponding to a subset of the elements of said set of elements and at least one of said phases being an evaluation phase; and
publishing a record at intervals of time, at least one interval coinciding with an annual management cycle, said record comprising a quantification of said performance indicators at the time of publishing.

2. A method for controlling a set of elements defined in a plan according to claim 1 further comprising steps of:
defining a set of data sources associated with said elements;
publishing a record of said elements, performance indicators, data sources and phases.

3. A method for controlling a set of elements defined in a plan according to claim 2 wherein said record of said elements, performance indicators, data sources and phases comprises a table.

4. A method for controlling a set of elements defined in a plan according to claim 1 wherein the step of defining a set of performance indicators comprises the further steps of:
defining a formulaic expression for calculating a quantity associated with a respective performance indicator;
defining a set of data sources for said formulaic expressions;
defining a target quantity associated with a respective performance indicator; and
defining a date associated with the target quantity.

5. A method for controlling a set of elements defined in a plan according to claim 4 further comprising an additional step of:
publishing a record of said performance indicators, and each of said respective formulaic expressions, said data sources, said respective target quantity, and said respective target quantity date.

6. A method for controlling a set of elements defined in a plan according to claim 5 wherein said record assumes a tabular form relating said performance indicators to respective formulaic expressions, data sources, target quantities, and target quantity dates.

7. A method for controlling a set of elements defined in a plan according to claim 1 wherein said plurality of phases comprises the phases of:
establishing an input phase wherein approvals are obtained for said plan;
establishing an activity phase wherein structures for executing said elements are defined;
establishing an output phase wherein said structures are implemented;
establishing an immediate outcome phase wherein a set of products of said structures are quantified;
establishing an intermediate outcome phase wherein a set of quality assessments of said set of products is quantified;
establishing an strategic outcome phase wherein an assessment of an overall performance against said plan is quantified.

8. The method of claim 7 wherein the step of defining a set of performance indicators comprises the further steps of:
defining a formulaic expression for calculating a quantity associated with a respective performance indicator;
defining a set of data sources for said formulaic expressions;
defining a target quantity associated with a respective performance indicator; and
defining a date associated with the target quantity.

9. A method for controlling a set of elements defined in a plan according to claim 8 further comprising an additional step of:
publishing a record of said performance indicators, and each of said respective formulaic expressions, data sources, target quantity, and target quantity date.

10. A method for controlling a set of elements defined in a plan according to claim 9 wherein
said record assumes a tabular form relating said performance indicators to respective formulaic expressions, data sources, target quantities, and target quantity dates.

11. A method for controlling a set of elements defined in a plan according to claim 1 wherein
each of said performance indicators has an associated reference indicator.

12. The method of claim 11 wherein
said associated reference indicator enumerates the performance indicator and indicates syntax and phase relationship among said elements.

13. The method of claim 12 wherein
said reference indicator has an alphabetic term differentiating each of said elements.

14. The method of claim 12 wherein
said reference indicator has a first numeric terms indicative of phase relationship and
a second numeric term enumerating the performance indicator.

15. A method for controlling a set of elements defined in a plan according to claim 4 wherein
said record comprises a table.

16. The method of claim 15 wherein said table comprises
an entry corresponding to each performance indicator;
an entry for a value calculated appropriate to the publishing time according to the respective formulaic expression for each performance indicator; and
the respective associated target for each performance indicator.

17. The method of claim 16 wherein said table further comprises
a performance indication relating said calculated value to said associated target.

18. The method of claim 17 further comprising the step of
defining at least one threshold for said performance indication; and
providing a status indicator relating said performance indication said at least one threshold.
